(19) United States
(12) Patent Application Publication
(10) Pub. No.: US 2002/0184340 A1
(43) Pub. Date: Dec. 5, 2002

(54) XML aware logical caching system

(76) Inventors: Alok Srivastava, Chelmsford, MA (US); Marco Carrer, Nashua, NH (US); Wai-Kwong (Sam) Lee, Nashua, NH (US); Paul Lin, Nashua, NH (US); Cheng Han, Nashua, NH (US); Wei Qain, Nashua, NH (US)

Correspondence Address: CHARLES G. CALL, 68 HORSE POND ROAD, WEST YARMOUTH, MA, 02673-2516, US

(21) Appl. No.: 09/871,440

(22) Filed: May 31, 2001

(51) Int. Cl. G06F 15/16

(52) U.S. Cl. 709/219

(57) ABSTRACT

A cache system for storing request messages expressed in Extended Markup Language (XML) and the responses to those messages. The inbound request message, which typically takes the form of an HTTP request message containing an XML request document as its payload, is received via the Internet from a remote sender. The XML request portion of the inbound message is then translated into canonical form, preferably conforming to the predetermined standard canonical form established as an Internet standard. The canonical XML request is then compared with previously received canonical requests. To speed the process of comparing the inbound canonical XML request with previously cached XML requests, an access key, such as a checksum or a hash integer, is generated from the content of the inbound request. The access key is then used to identify zero or more prior canonical requests which may match the inbound canonical request. A character-by-character comparison is then made between the inbound canonical request and those cached requests that share the same access key to determine whether a match exists. If a match is found, the cached response previously sent in response to the matching prior canonical request is returned to the remote sender. If a match is not found, the requested information is retrieved and packaged into a response message which is returned to the sender, and the both the keyed canonical XML request and the response are placed in cache memory.

### FIELD OF THE INVENTION

This invention relates to electronic data transmission systems and more particularly to methods and apparatus for caching XML request and response documents.

### BACKGROUND OF THE INVENTION

The Extended Markup Language XML is imposing itself as the standard for ebusiness transactions and other applications which need to exchange information between heterogeneous systems. In these networks, data is commonly exchanged by transmitting XML documents containing an information request to a database server, which responds by transmitting an XML document containing the requested information. The responding database server must often perform complex database functions in order to retrieve the requested information and package that information in an outbound XML response.

Request messages with XML payloads thus pose some new challenges to the implementers of Web database servers. When two or more equivalent XML requests are received, it would be desirable to return cached responses without the need to repeat the computation required to assemble the duplicate response. The desired caching operation is very similar to caching performed to speed the operation of conventional Web servers which compares the URL in an inbound request that specifies a desired resource with the URLs of cached copies of resources to determine whether a cached response is available.

The task of caching responses defined by requests expressed in XML is complicated by at least two factors. First, XML request documents are frequently lengthy, so that the task of comparing an inbound XML request document with prior cached requests would be orders of magnitude more burdensome that comparing URLs. Secondly, two XML requests which are logically identical may not have identical content. For example, requests coming from different hosts may contain different line ending characters or include different whitespace characters which change the form but not the meaning of the request. Notwithstanding the difficulties imposed by the length and variable form of XML document requests, there remains a clear need for an mechanism for an XML request and response caching system capable of efficiently recognizing and providing a cached response to any XML request document which is logically equivalent to a prior request document.

### SUMMARY OF THE INVENTION

The present invention takes the form of methods and apparatus for responding to an incoming request message expressed in the Extended Markup Language (XML) and responding, when possible, by sending a cached, previously transmitted response to a logically equivalent XML request. The inbound request message, which typically takes the form of an HTTP request message containing an XML request document as its payload, is received via the Internet from a remote sender. The XML request portion of the inbound message is then translated into canonical form, preferably conforming to the predetermined standard canonical form established as an Internet standard. The canonical XML request is then compared with previously received canonical requests. If a match is found, the cached response previously sent in response to the matching prior canonical request is returned to the remote sender. If a match is not found, the requested information is retrieved and packaged into a response message which is returned to the sender, and the both the canonical XML request and the response are placed in cache memory.

To speed access the process of comparing the inbound canonical XML request with previously cached XML requests, an access key, such as a checksum or a hash integer, is generated from the content of the inbound request. The access key is then used to identify zero or more prior canonical requests which may match the inbound canonical request. A character-by-character comparison is then made between the inbound canonical request and those cached requests which share the same access key to determine whether a match exists.

By first converting all inbound requests expressed in XML in the a standard form, requests which are logically equivalent are made identical at the character level. By using the XML standard canonical form defined the standards-setting body, the World Wide Web Consortium, the conversion to canonical form can be made with assurance that the logical meaning of the request is not altered. In this way, it becomes possible to deliver a cached response to a request which is logically equivalent to a prior request, but which has different character content.

By forming an access key such as a checksum or a hash of the canonical request, cache look-ups can be much more rapidly performed. Upon receiving a new request, the look-up operation will first compute the access key for the canonical representation of the XML request, and then compare the access key with the access keys for cached requests, an operation which is highly optimized by current database systems as it can be modeled a traditional index over a NUMBER type column. Then, only those prior XML request documents having the same access key need be compared byte-by-byte with the inbound canonical request to determine if a cached copy of the response is available. The approach reduces significantly the number of comparisons to be performed and allows a fast cache retrieval when XML is used for specifying look-up criteria.

When used with a Web database server that produces XML responses to XML requests, the present invention allows a cached XML response to be returned whenever an incoming XML request is logically equivalent to a cached request, even though its character content may differ. This in turn enables the system to immediately return cached XML responses without any additional processing. The data packaged into the request XML payload do not need to be moved into the internal system representation before a cache hit can be determined. Moreover, there is no more a need for additional packaging of the response data into an XML message if the response has already been cached in the desired XML format.

These and other objects, features and advantages of the present invention may be better understood by considering the following detailed description of an illustrative preferred embodiment of the invention. In the course of this description, frequent reference will be made to the attached drawings

### BRIEF DESCRIPTION OF THE DRAWING

FIG. 1 is a flow chart which illustrates the operation of the invention.

### DETAILED DESCRIPTION

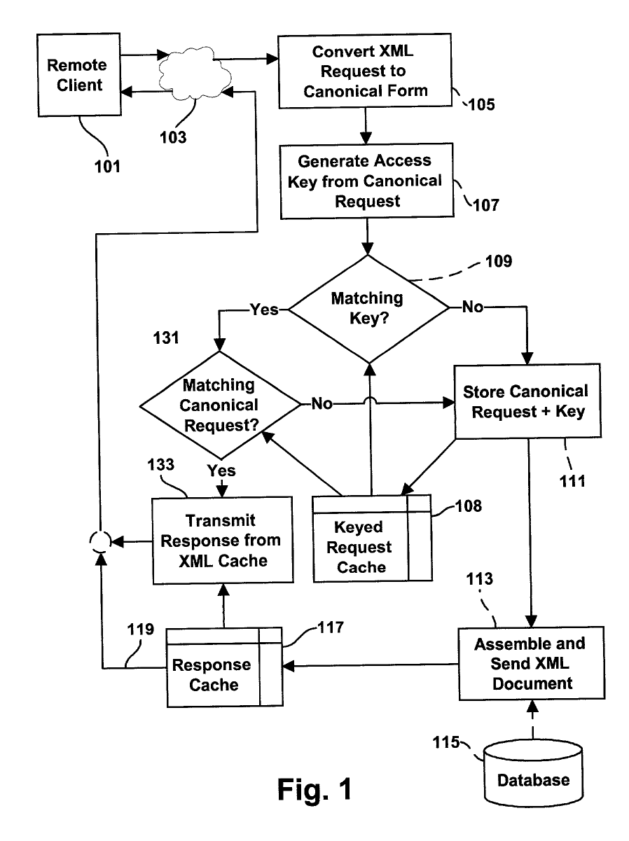

As seen in FIG. 1, request messages are sent from a client 101 via the Internet 103 to a database server which processes the request by first converting the XML content of the request into canonical form as indicated at 105.

The request and response messages to be described are typically (although not necessarily) transmitted using the Hypertext Transfer Protocol (HTTP), an application-level protocol used by the World-Wide Web global information system. Version 1.1 (referred to as “HTTP/1.1”) of that protocol is specified in the Internet Standards Track Request for Comment document RFC 2616, Hypertext Transfer Protocol—HTTP/1.1 (June, 1999). The HTTP protocol is a request/response protocol. A client sends a request to the server in the form of a request method, URI, and protocol version, followed by a MIME-like message containing request modifiers, client information, and body content over a connection with a server. Request and response messages use the generic Internet message format as defined in the Internet Standards Track Request for Comment document RFC 822, Standard for the Format of ARPA Internet Text Messages (August 1982) for transferring entities (the payload of the message). Both types of message consist of a start-line, zero or more header fields (also known as “headers”), an empty line (i.e., a line with nothing preceding the carriage-return, line feed characters) indicating the end of the header fields, and possibly a message-body. The server responds with a status line, including the message's protocol version and a success or error code, followed by a MIME-like message containing server information, entity meta-information, and possible entity-body content.

More specifically, the request message may take the form of an HTTP POST message to the server containing header fields designating the content type as “text/xml” and specifying the content-length. The payload of the HTTP request may be sent in the message body as an XML document which describes the request. As used in this specification, unless otherwise noted, the terms “request” and “request message” refer to the XML content of the request message, regardless of the pathway or protocol used to deliver that content.

By way of example, the following listing illustrates an example of an XML request document imbedded in an HTTP request message. The sample below conforms to the Simple Object Access Protocol (SOAP) 1.1, W3C Note, May 8, 2000:

POST /StockQuote HTTP/1.1

Host: www.stockquoteserver.com

Content-Type: text/xml; charset=“utf-8”

Content-Length: nnnn

SOAPAction: “Some-URI”

<SOAP-ENV:Envelope

xmlns:SOAP-ENV=“http://schemas.xmisoap.org/soap/envelope/”

SOAP-ENV:encodingStyle=“http://schemas.xmlsoap.org/soap/encoding/”>

<SOAP-ENV:Body>

<m:GetLastTradePrice xmlns:m=“Some-URI”>

<symbol>DIS</symbol>

</m:GetLastTradePrice>

</SOAP-ENV:Body>

</SOAP-ENV:Envelope>

Other XML protocols which employ XML to form information requests include WebBroker, XML-RPC, BizTalk, ebXML, XMI, WebDAV, ICE and IOTP. See generally, XML Architecture Domain, XML Protocols at http://www.w3.org/2000/xp/.

The present invention may be applied to particular advantage to improve the performance of a Web database server which employs a relational database to store data and which frequently assembles the content of HTTP response messages from data fetched from the relational tables to satisfy all or part of the request. For more complex requests, substantial processing may be required to retrieve and package the requested data into a desired form, such as an XML document or an HTML Web page. For this reason, it is desirable to employ a cache mechanism that can eliminate the need to repeat these computations when two or more logically equivalent requests are received. Unless otherwise noted, the terms “response” and “response message” refer to at least that portion of the outbound data that the server returns to the requestor and that can be usefully stored in a cache storage unit to reduce need for repetitive database search and response packaging operations.

The preferred embodiment to be described is a “server-side” cache that has the twin goals of (1) providing more rapid responses to duplicative requests and (2) reducing the computational burden placed on the database server. It should be noted, however, that the principles of the invention could also be applied to advantage in implementing a client-side cache where requests are expressed as the content of an XML document. In a such a client-side XML request/response cache, the mechanism for comparing new XML requests with those for which cached responses as described in this specification would be combined with the client-side cache-control mechanism specified, for example, in Section 13 of RFC 2616, Hypertext Transfer Protocol—HTTP/1.1 (June, 1999).

Request Message Processing

The first step in handling an inbound XML request message as shown at 105 is to place that message in canonical form. Any XML document is part of a set of XML documents that are logically equivalent within an application context, but which vary in physical representation based on syntactic changes permitted by the XML specification Extensible Markup Language (XML) 1.0 (Second Edition), W3C Recommendation, Oct. 3, 2000 and the Namespace Specification Namespaces in XML, W3C, Jan. 14, 1999. A method for the canonical form of an XML document that accounts for variations that are permissible under the XML specification is described in Canonical XML Version 1.0, W3C Proposed Recommendation, Jan. 19, 2001. Except for limitations regarding a few unusual cases, if two documents have the same canonical form, then the two documents are logically equivalent within the given application context. If an incoming request is logically equivalent to a prior request having a cached response, that cached response may be returned to the requestor. Accordingly, the inbound request is first converted to canonical form at 105 so that it can be compared to prior requests which were also converted to canonical form to determine if a logically equivalent request and its response are available in cache storage.

The canonical form of the inbound XML document is physical representation of the document produced by the method described in detail in the Canonical XML Version 1.0 specification. The steps performed at 105 by this standard method are summarized in the following list:

1. The document is encoded in UTF-8 (an established character coding standard)

2. Line breaks normalized to the hexadecimal value A on input, before parsing

3. Attribute values are normalized, as if by a validating processor

4. Character and parsed entity references are replaced

5. CDATA sections are replaced with their character content

6. The XML declaration and document type declaration (DTD) are removed

7. Empty elements are converted to start-end tag pairs

8. Whitespace outside of the document element and within start and end tags is normalized

9. All whitespace in character content is retained (excluding characters removed during line feed normalization)

10. Attribute value delimiters are set to quotation marks (double quotes)

11. Special characters in attribute values and character content are replaced by character references

12. Superfluous namespace declarations are removed from each element

13. Default attributes are added to each element

14. Lexicographic order is imposed on the namespace declarations and attributes of each element

Next, as indicated at 107, an access key value is generated from the canonical request. This access key can take the form of a checksum integer formed by adding together the data values which form the characters of the canonical request, or by applying a hash function to the canonical request. The resulting access key is employed as an address of a lookup table used by the keyed request cache store 108 which holds previously received canonical requests. If, at 109, it is determined that no prior request producing the same key value has been stored, the inbound canonical request is stored in at an available location associated with the access key as shown at 111. The database server then satisfies the request specified by the inbound request as seen at 113, fetching the needed data from the database 115 and packaging the retrieved data to form an outbound response message which is sent to the requesting client as indicated at 119 and stored in the response cache 117.

If, at 109, it is determined that one or more prior requests were received that produced the same access key as the inbound request, each of these prior requests having the same key is compared, character-for-character with the inbound request as indicated at 131. When a matching request is found, it is known that the inbound request and the matching request are logically equivalent, even though the two requests may not have been identical before they were converted to canonical form. If the character-by-character comparison at 131 reveals that no prior request having the same key was previously received, control is passed to step 111 and the process continues as previously described with the storage or the canonical request.

Because the underlying data in the database 115 may change, with the result that responses previously stored in the response cache 117 may no longer be current, an expiration date and time may be stored with each request in the request cache 108. Expired requests and the corresponding responses may then be periodically purged from the cache stores 108 and 117 respectively, and expired requests may be ignored at step 131.

Conclusion

It is to be understood that the preferred embodiment described above is merely one illustrative application of the principles of the invention. Numerous modifications may be made to the apparatus and methods described without departing from the true spirit and scope of the invention.

What is claimed is:

1. The method of responding to an incoming request message from a sender which comprises, in combination, the steps of:
converting said incoming request message into an incoming canonical request message expressed in a predetermined standard form,
comparing said incoming canonical request message with previously received and stored canonical request messages, and
if a match is found between said incoming canonical request message and a given previously stored canonical request message, accessing a stored response previously transmitted in response to said given previously stored canonical message, and returning said stored response to said sender.

2. The method of responding to an incoming request message as set forth in claim 1 wherein at least a portion of said incoming request message is expressed in the Extensible Markup Language and wherein said step of converting translates said portion into standard canonical XML form.

3. The method of responding to an incoming request message as set forth in claim 1 wherein said step of comparing comprises the substeps of:
generating an access key value based on the content of said incoming canonical request message;
accessing zero or more selected ones of said previously received and stored canonical request messages which are specified by said access key value, and
comparing said incoming canonical request message with said selected ones of said previously received and stored canonical request messages.

4. The method of responding to an incoming request message as set forth in claim 3 wherein, when no match is found between said incoming canonical request message and a previously stored canonical request message, performing the step of storing said incoming canonical request message in a first storage location specified by said access key.

5. The method of responding to an incoming request message as set forth in claim 4 wherein, when no match is found between said incoming canonical request message and a previously stored canonical request message, performing the further steps of:
generating a new response message containing data specified by said incoming request message,
transmitting said new response message to said sender, and
storing said new response message at a second location associated with said first location.

6. The method of responding to an incoming request message expressed in the Extended Markup Language which comprises, in combination, the steps of:
receiving said incoming request message via the Internet from a remote sender
converting said incoming request message into an incoming canonical request message expressed in an established standard format,
comparing said incoming canonical request message with previously received and stored canonical request messages,
if a match is found between said incoming canonical request message and a given previously stored canonical request message, accessing a stored response previously transmitted in response to said given previously stored canonical message, and returning said stored response to said sender, and
if a match is not found between said incoming canonical request message and a given previously stored canonical request message, performing the steps of:
generating a new response message containing data specified by said incoming request message,
transmitting said new response message to said sender, and
storing said incoming canonical request message and said new response message at associated storage locations.

7. The method of responding to an incoming request message as set forth in claim 6 wherein said step of comparing comprises the substeps of:
generating an access key value based on the content of said incoming canonical request message;
accessing zero or more selected ones of said previously received and stored canonical request messages which are specified by said access key value, and
comparing said incoming canonical request message with said selected ones of said previously receive and stored canonical request messages.

8. The method of caching XML request messages and the responses thereto transmitted via the Internet which comprises, in combination, the steps of:
receiving an inbound HTTP message containing a request expressed in Extended Markup Language from a sender,
translating said request into an inbound canonical request expressed into an inbound canonical request expressed in a predetermined standard canonical format, and
comparing said inbound canonical request with previously stored canonical requests, and, if a match is found with a particular one of said stored canonical requests, returning to said sender a stored copy of a response message previously transmitted in response to said particular one of said stored canonical requests.

9. The method of responding to an incoming request message as set forth in claim 8 wherein said step of comparing comprises the substeps of:
generating an access key value based on the content of said inbound canonical request message;
accessing zero or more selected ones of said previously received and stored canonical request messages which are specified by said access key value, and
comparing said incoming canonical request message with said selected ones of said previously receive and stored canonical request messages.

10. Apparatus for responding to an incoming request message which comprises, in combination,
means for receiving said request message from a remote sender via a data communications link,
a translator for converting said incoming request message into an incoming canonical request message expressed in a predetermined standard form,
a request cache memory for storing received canonical request messages,
a comparator for matching said incoming canonical request message with previously received canonical request messages in said request cache memory,
a response cache memory,
means coupled to said comparator and responsive to a match between said incoming canonical request message and a given previously stored canonical request message for identifying a previously transmitted response to said given previously stored canonical message, and
transmission means for sending said previously transmitted response to said remote sender via said communications link.

11. The apparatus set forth in claim 10 wherein at least a portion of said incoming request message is expressed in the Extensible Markup Language and wherein translator converts said portion into standard canonical XML form.

12. The apparatus set forth in claim 10 wherein said comparator comprises:
means for generating an access key value based on the content of said incoming canonical request message;
means for retrieving zero or more selected ones of said previously received and stored canonical request messages from locations in said request cache memory which are specified by said access key value, and
means for comparing said incoming canonical request message with said selected ones of said previously received and stored canonical request messages

13. The apparatus set forth in claim 12 further including means responsive to the condition occurring when no match is found between said incoming canonical request message and a previously stored canonical request message for storing said incoming canonical request message at a location in said request cache memory specified by said access key.

14. The apparatus set forth in claim 13 further wherein said means responsive to the condition when no match is found between said incoming canonical request message and a previously stored canonical request message further includes:
means for generating a new response message containing data specified by said incoming request message,
means for transmitting said new response message to said sender, and
means for storing said new response message in said response cache memory.

15. Apparatus for responding to an incoming request message expressed in the Extended Markup Language which comprises, in combination:
an Internet connection for receiving said incoming request message via the Internet from a remote sender,
a translator for converting said incoming request message into an incoming canonical request message expressed in an established standard format,
a cache memory for storing previously received and converted canonical request messages and corresponding previously transmitted responses to said previously received request messages,
a comparator for comparing said incoming canonical request message with said previously received and stored canonical request messages in said cache memory,
means coupled to said comparator and responsive to a detected match between said incoming canonical request message and a given previously stored canonical request message for identifying that given previously transmitted response in said cache memory that was transmitted in response to said given previously stored canonical request, and for transmitting said given response to said remote sender via said Internet connection.

16. The apparatus set forth in claim 15 wherein said comparator comprises:
means for generating an access key value based on the content of said incoming canonical request message;
means for retrieving zero or more selected ones of said previously received and stored canonical request messages from locations in said cache memory which are specified by said access key value, and
means for comparing said incoming canonical request message with said selected ones of said previously received and stored canonical request messages.

17. In combination with a Web database server, a cache memory system for storing XML request messages and the responses thereto, said cache memory system comprising, in combination,
an Internet connection for receiving HTTP request messages from and returning HTTP response messages to a remote client,
an inbound message port for receiving HTTP request messages at least some of which contain a request payload expressed in Extended Markup Language,
a translator for converting each request payload into an inbound canonical request which conforms to a predetermined standard canonical format,
a memory for storing previously received inbound canonical requests and the outbound responses thereto,
a comparator for comparing each inbound canonical request canonical request with previously stored canonical requests in said memory to identify a matching one of said stored canonical requests, and
transmission means coupled to said comparator for returning a stored copy of that previously transmitted response in said memory that was previously transmitted in response to said matching one of said stored canonical requests.

18. The apparatus set forth in claim 17 wherein said comparator comprises:
means for generating an access key value based on the content of said inbound canonical request message;
means for retrieving zero or more selected ones of said previously received and stored canonical request messages from locations in said memory which are specified by said access key value, and
means for comparing said incoming canonical request message with said selected ones of said previously received and stored canonical requests to identify a matching one of said requests.
